(19) United States
(12) Patent Application Publication
(10) Pub. No.: US 2003/0123159 A1
(43) Pub. Date: Jul. 3, 2003

(54) Diffraction lens element and lighting system using the lens element

(76) Inventors: Masayuki Morita, Saitama (JP); Kanto Miyazaki, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/275,867

(22) PCT Filed: Mar. 5, 2002
(86) PCT No.: PCT/JP02/02017

(30) Foreign Application Priority Data
Mar. 9, 2001 (JP) 2001-66010

(51) Int. Cl. G02B 3/08; G02B 5/32; G02B 27/44

(52) U.S. Cl. 359/742; 359/565; 359/19

(57) ABSTRACT

By proposing a diffractive optical element having optical functions of a random phase plate and a lens array in combination, and an illumination apparatus employing this lens element, reduction of speckles, and improvements in energy efficiency and light utilization efficiency are achieved simultaneously.

In a transparent base material, by individually assigning or superimposing an amount of variation in accordance with a random number onto each of the depths of recessed portions constituting steps equivalent in value to a lens or a lens array, recessed portions having irregular phase variations are formed and a diffractive lens element (6) is made. Also, in an illumination apparatus employing this diffractive lens element and a laser light source, in order to obtain a uniform illumination light from which speckles are eliminated, the diffractive lens element (6) is rotated by a rotating means.

### TECHNICAL FIELD

The present invention relates to a technique for eliminating speckles in an illumination apparatus using a coherent light source and a phase type diffractive optical element.

### BACKGROUND ART

With the miniaturization of semiconductors in recent years, a high resolution is demanded of semiconductor inspection apparatuses using an optical microscope. For such a purpose, two methods including NA (Numerical Aperture) heightening and wave-length shortening are conceivable, however, since an immersion objective lens cannot be used for purposes of inspecting semiconductor apparatuses, there is imposed a restriction such that “NA<1.0.” As such, there is known an apparatus which utilizes deep ultraviolet laser so as to achieve high resolution by wave-length shortening, and which is made capable of achieving approximately twice the resolution by observing an object with approximately half the wave-length of visible light.

However, when using a laser as a light source, there are problems in that speckle patterns (when a highly coherent light source is used and the phase of the image forming light becomes disordered, an interference pattern of an irregular form is superimposed on the image) occur in the image, and a desired resolution cannot be achieved.

In order to eliminate the patterns mentioned above, methods indicated below are known.

(1) A method in which a rotary diffusion plate is provided inside an illumination optical system:

(2) A method in which a fiber-bundle (the difference in length is made greater than the coherence length of the laser) is used for an illumination optical system (for example, Japanese Laid-Open Patent Publication No. HEI 6-167640).

However, in method (1) using a rotary diffusion plate, the following problems are present.

Efficiency is not good because energy loss due to scattering and reflection at the diffusion plate is large.

A large portion of the light is discarded and wasted, and the efficiency in light utilization is low, because, since the radiance becomes lower the greater the angle of emergence of the light from the diffusion plate becomes, in an apparatus such as a microscope which requires uniform light, only the light in a portion of a limited region in which the angle of emergence is small contributes to the formation of the image.

Further, in the case of method (2) mentioned above, for each of the fibers, it is necessary to set a difference in length greater than the coherence length of the laser, and as a result, the entire length of the fiber bundle becomes extremely long. Therefore, energy loss becomes prominent especially in the deep ultraviolet region having low transmittance, because with respect to the light propagated inside the fiber, it is attenuated in proportion with the square of the fiber length.

Accordingly, the present invention makes it an issue to reduce speckles and improve energy efficiency and light utilization efficiency at the same time by proposing a diffractive optical element having the optical functions of a random phase plate and a lens array, and an illumination apparatus employing such an element.

### BRIEF DESCRIPTION OF THE DRAWINGS

FIG. 1A through FIG. 1C are explanatory diagrams regarding the formation of a phase-type diffractive optical element;

FIG. 2 is a diagram illustrating an example of the form of a micro-lens;

FIG. 3 is a diagram illustrating an example of the form of a random phase plate;

FIG. 4 is a diagram illustrating an example of the form of a lens element according to the present invention;

FIG. 5 is a diagram illustrating an example of the form of a cross-section of a micro-lens;

FIG. 6 is a diagram illustrating an example of the form of a cross-section of a random phase plate;

FIG. 7 is a diagram illustrating an example of the form of a cross-section of a lens element according to the present invention;

FIG. 8 is a diagram illustrating an example of a configuration in which an illumination apparatus according to the present invention is applied to an optical microscope; and

FIG. 9 is a diagram illustrating a different example of a configuration in which the illumination apparatus according to the present invention is applied to an optical microscope.

### DISCLOSURE OF THE INVENTION

In order to solve the issue mentioned above, the diffractive lens element according to the present invention is one in which, in the transparent base material, recessed portions having irregular phase variations are formed by individually adding or superimposing a variation amount in accordance with a random number to the depth of each of the recessed portions constituting steps that are equivalent in value to a lens or a lens array.

Further, in order to obtain a uniform illumination light from which speckles are eliminated, the illumination apparatus according to the present invention is one in which a laser light source and a rotating means for rotating the diffractive lens element mentioned above is provided.

Thus, according to the present invention, the diffractive lens element also has the optical functions of a lens or a lens array, and a random phase plate, and by rotating it, it is possible to suppress speckle patterns, while also reducing energy loss and improving the efficiency of light utilization, because there is no need to use a diffusion plate.

### BEST MODES FOR CARRYING OUT THE INVENTION

The present invention relates to a diffractive optical element and an optical apparatus using such an optical element. In addition, the diffractive lens is something which is drawing attention as an optical element to replace conventional spherical lenses, and include, for example, a binary phase type diffractive optical element.

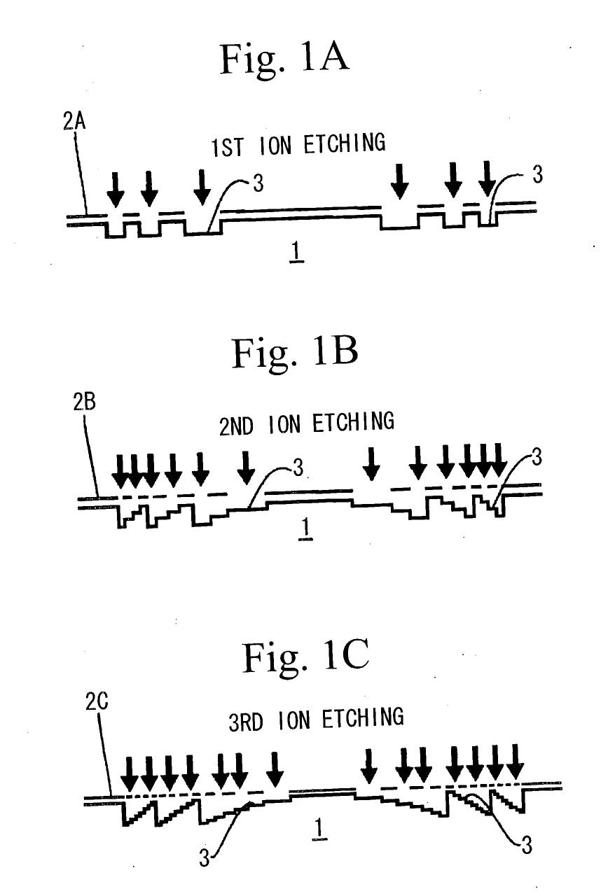

FIG. 1A schematically indicates an example of the formation of a 2-stage level binary optical element. By covering a tabular transparent base member 1 with a mask 2A, and performing an ion-etching treatment, grooves or recessed portions 3, 3, . . . corresponding to the mask pattern are formed. In addition, here, what is meant by 2-stage is that it includes 2 conditions: a case in which recessed portions are formed, and a case in which they are not. Accordingly, if levels of 4 stages are set, as shown in FIG. 1B, four conditions including a case where a second mask 2B is laid and the recessed portions are not formed (zero depth), and 3 stages of depths become possible. Further, as shown in FIG. 1C, in 8 stages in which a third mask 2C is laid, 8 conditions including a depth of zero become possible.

By proceeding with such operations, it can be seen that detailed steps comprising 2 to the power n types of depths (including zero depth) can be formed. In other words, by forming numerous recessed portions with different depths in the transparent base member 1, the form of the cross section is formed in a step-like shape, and an extremely precise element having good diffraction efficiency can be fabricated (In particular, it is suitable for manufacturing micro-optical elements).

In addition, if (the formed pattern of a Fresnel step form), of which only the shape of the cross-section is shown in FIG. 1A through FIG. 1C, has, for example, symmetry around the center axis of rotation of the transparent base material 1, it can be seen that the form viewed from the direction of this central axis (optical axis) makes a concentric circle shape, and that it has lens functions comparable to a spherical lens.

By employing the technology above, it becomes possible to replace microscopic lens elements such as a micro-lens and diffractive optical elements such as a random phase plate (an item which makes the phase of the wavefront of an illumination light random such that it does not have a uniform pattern), however, what becomes a problem here is rectilinear light (zeroth order diffraction light). In other words, in a diffractive optical element, due to the properties thereof, zeroth order diffraction light does occur, however, this zeroth order diffraction light is non-functional in terms of the optical functions as a diffractive optical element.

Therefore, when employing a diffractive optical element, the elimination of speckle patterns is accompanied by a problem (such as a reduction in efficiency and an increase in the number of component parts and cost) such that a need to take countermeasures such as eliminating the zeroth order diffraction light with a spatial filter arises.

Accordingly, in the present invention, by using a diffractive lens element having optical functions of both a lens or a lens array and a random phase plate in one diffractive optical element, not only the functions of a lens, but also the functions of a random phase plate, in other words, irregular phase assignment are made use of, and as a result, it is possible to realize the elimination of zeroth order diffraction light and speckle patterns without employing a spatial filter and the like.

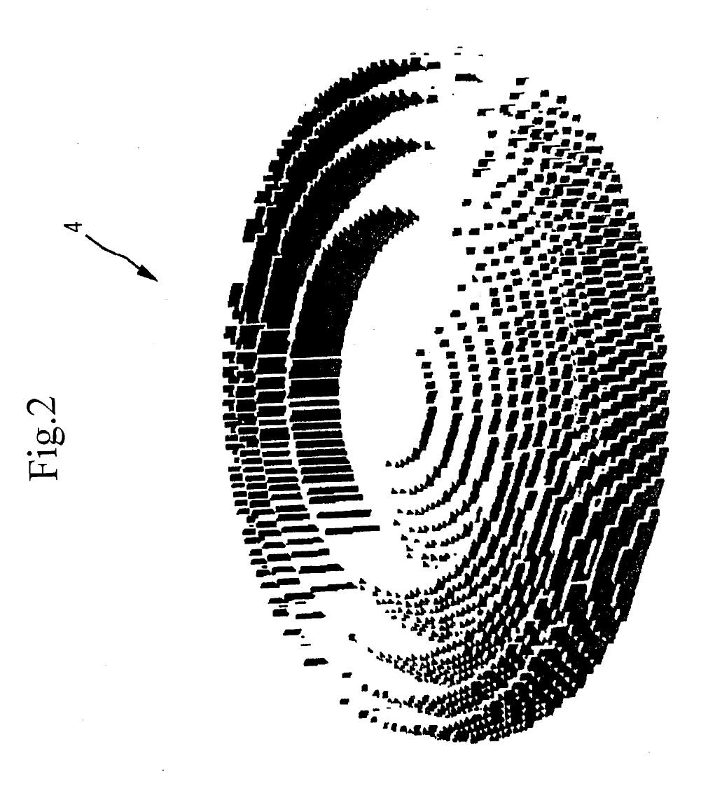

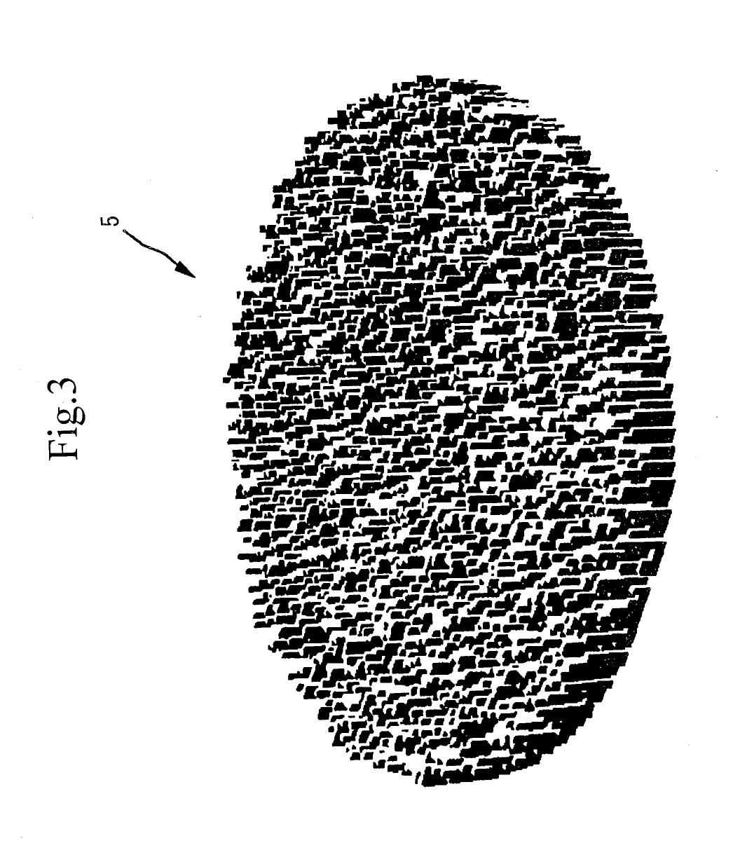

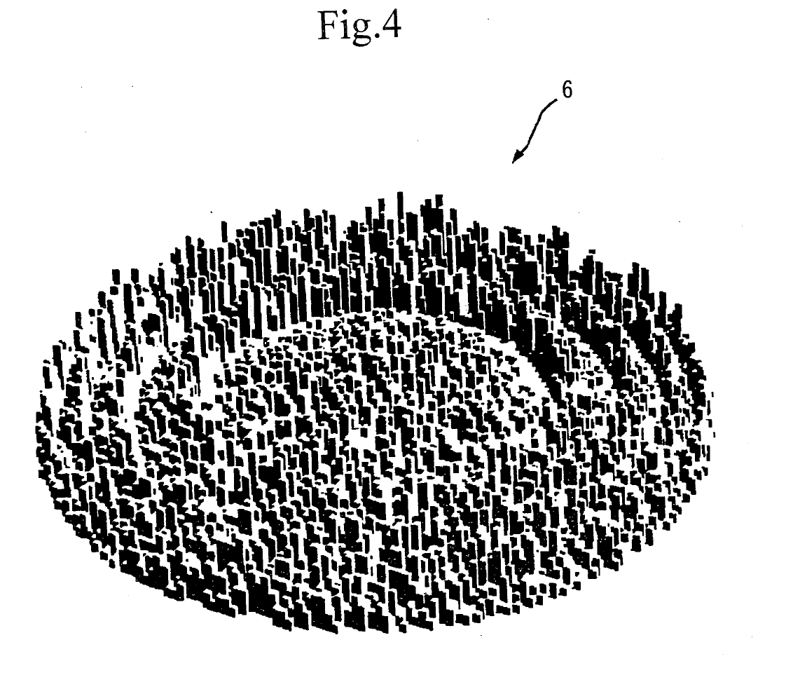

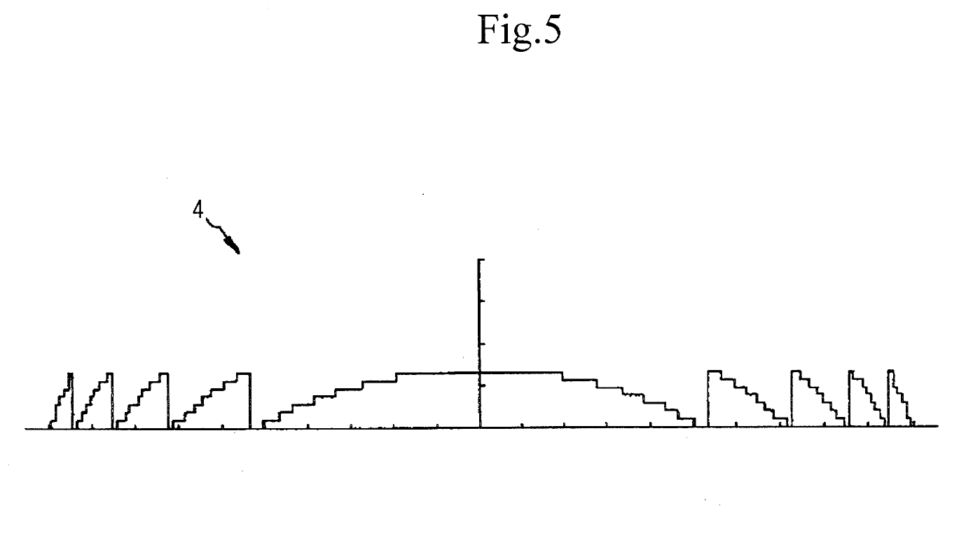

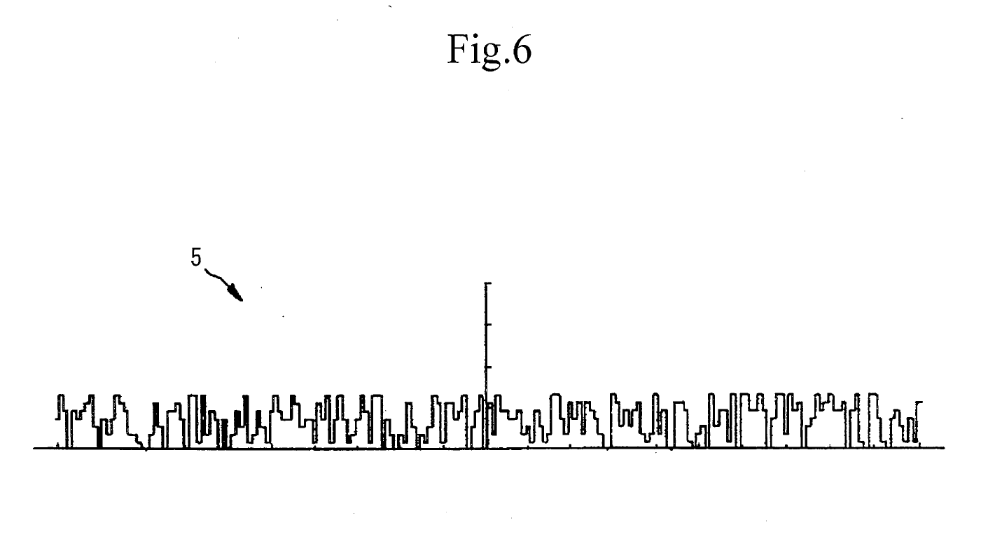

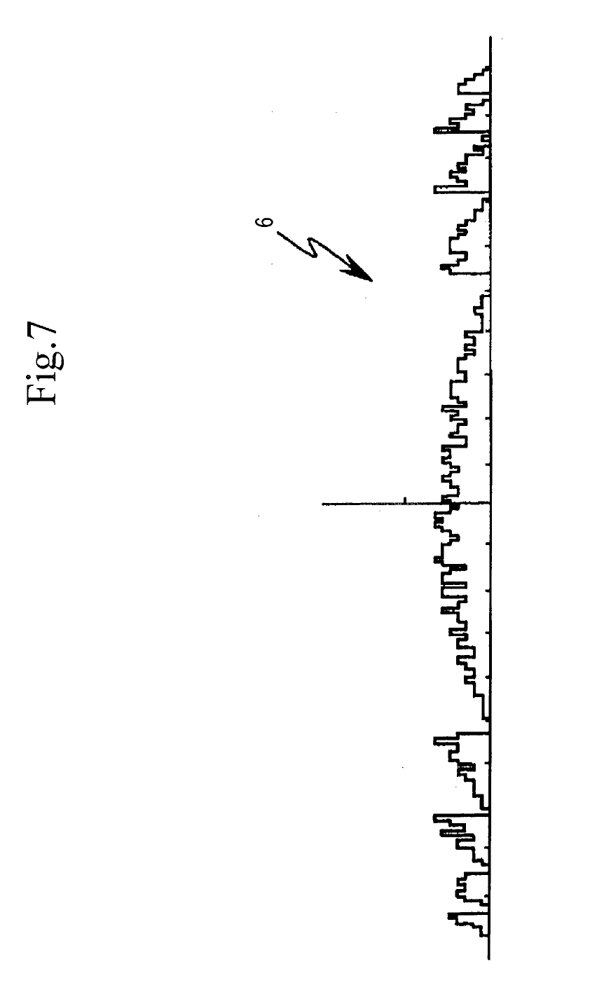

FIG. 2 through FIG. 7 show in contrast the respective examples when a micro-lens 4, a random phase plate 5, and a diffractive lens element 6 according to the present invention are made as diffractive optical elements. FIG. 2 and FIG. 5, FIG. 3 and FIG. 6, and FIG. 4 and FIG. 7 respectively show the micro-lens, the random phase plate, and the diffractive lens element according to the present invention. In order to show the characteristics of the shape of each optical element in a manner that is easy to understand, the diagrams shown in FIG. 2 through FIG. 4 express the image data indicating their shapes in 2-tone after a gray scale conversion. FIG. 5 through FIG. 7 show the shape of a cross-section (a step shape) at a plane surface including an optical axis or a base axis.

FIG. 2 shows an example of the shape of the micro-lens 4 constituting a micro-lens array (an optical element having a configuration in which micro-lenses are arranged in an orderly manner in a two-dimensional array form), and has rotational symmetry around the optical axis thereof. And as shown in FIG. 5, the shape of the cross-section of the plane surface including the optical axis of this lens takes on an orderly step shape.

As shown in FIG. 3, the random phase plate 5 has irregular recesses and protrusions, and the shape of the cross-section thereof resembles that shown in FIG. 6. In addition, such a shape is formed by sectioning the surface of the transparent base member into a meshed form while also irregularly varying the depth of the recessed portions by way of random numbers.

As shown in FIG. 4, the diffractive lens element 6 has a form as though irregular recesses and protrusions were added with respect to the shape of the micro-lens 4. In other words, as shown in FIG. 7, although it has step-like tendencies of the micro-lens 4 when viewed in perspective, it has an irregular shape when viewed closely. In the phase type diffractive optical element mentioned above, such a shape is formed as recessed portions having irregular phase variations by individually adding or superimposing a variation amount in accordance with a random number onto the depth of each of the recessed portions constituting steps having optical functions comparable to a lens.

For example, by individually assigning a variation amount with respect to the depth of recessed portions generated by a random number function (or a pseudo-random number function), it is possible to create irregular phase variations.

In addition, in regard to the function as a random phase plate, in the case that manufacture is difficult if completely random phase variations are assigned by way of a random function, phase variations of a plurality of stages within a phase range of 0˜2π may be established, and be selected therefrom at random.

With respect to an illumination apparatus for obtaining a uniform illumination light in which speckles are eliminated or reduced using an optical element in which a plurality of such diffractive lens elements 6 are arranged on one sheet of transparent base material, a rotating means for rotating the diffractive lens element is provided. In other words, by rotating (for example, at a rotation rate of one hundred to ten several hundred rpm) the diffractive lens element within a plane surface perpendicular to the optical axis, it is possible to generate spatially and temporally random phase variations, and it is possible to suppress speckle patterns peculiar to coherent light. Further, since the separate preparation of the micro-lens array and the random phase plate may be dispensed with, system configuration is simplified, and it is also advantageous in terms of lowering cost.

In addition, the illumination apparatus according to the present invention is widely applicable to a variety of optical apparatuses employing a coherent light source (a light source with high interference) of a single wavelength, such as an optical microscope using multiple-mode optical fibers, a pattern exposure apparatus, or an optical molding apparatus, for example.

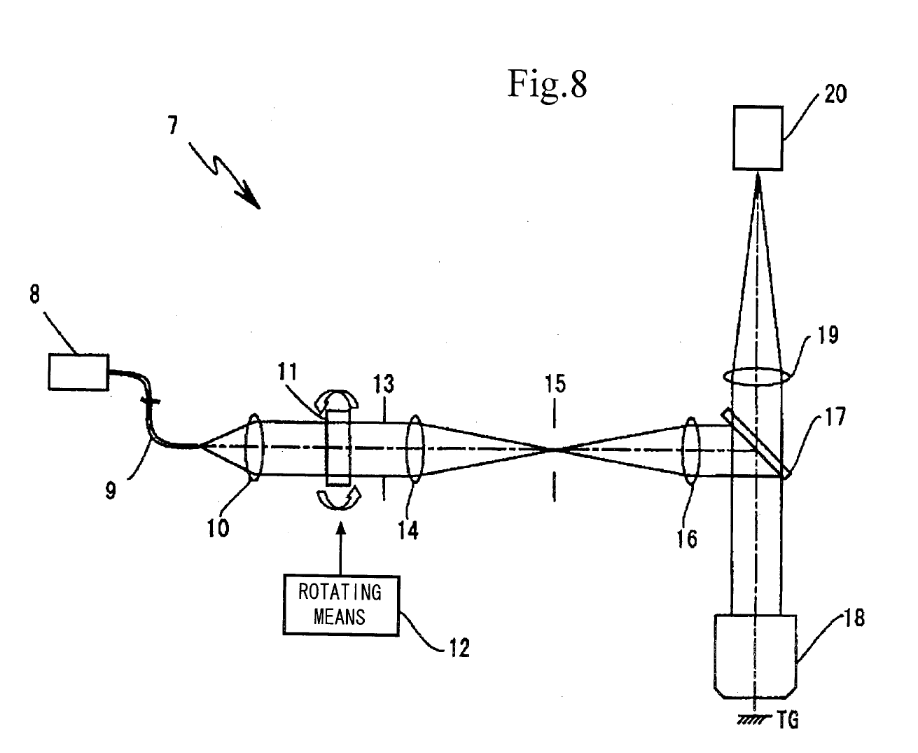

As an example of an application of the illumination apparatus according to the present invention, FIG. 8 shows a configuration example 7 of a microscope employing a diffractive lens element, and is basically said to be the configuration of Koehler illumination.

A laser light propagated through an optical fiber 9 from a laser light source 8 of SHG (Second harmonic generation)-Ar laser and capable of continuous oscillation, first becomes a parallel luminous flux by being spread by a condenser lens 10, and is irradiated on a diffractive lens element 11 (see FIG. 4 and FIG. 7 for the individual lens elements).

As indicated with arrows, the diffractive lens element 11 is such that it is rotated around the central axis by a rotating means 12 including a motor or the like. Light transmitted through the diffractive lens element 11 reaches a mirror 17 (a semi-transparent mirror) via a lens 16 after going through an aperture stop 13, a lens 14, and a field stop 15.

Then, the light irradiated on a sample object (TG) via an object lens 18 is received by an imaging apparatus (for example, a CCD type camera, a film type camera or the like) 20 via the mirror 17 and an image forming lens 19.

According to the present configuration, by rotating the diffractive lens element 11, it is possible to generate a random phase variation, and speckle patterns peculiar to coherent light may be eliminated. In other words, because the amount of light received is averaged and speckle pattern noise is reduced by way of integration within an image capturing period (or charge storing period) for an image pick-up element inside the imaging apparatus 20 constituting an observation system or by way of integration within an exposure period for a film type camera, it is possible to increase the S/N (signal to noise) ratio.

In addition, when employing deep ultraviolet rays for the purpose of shortening the wavelength, quartz may be conceived as a glass material to be used in the diffractive lens element or the lens.

Further, although in the present example, one diffractive lens element is used (for example, forming elements on both surfaces), various embodiments, such as configuring an optical system in which a plurality of diffractive lens elements are combined as deemed appropriate, and rotating the entire optical system or a part thereof, are possible.

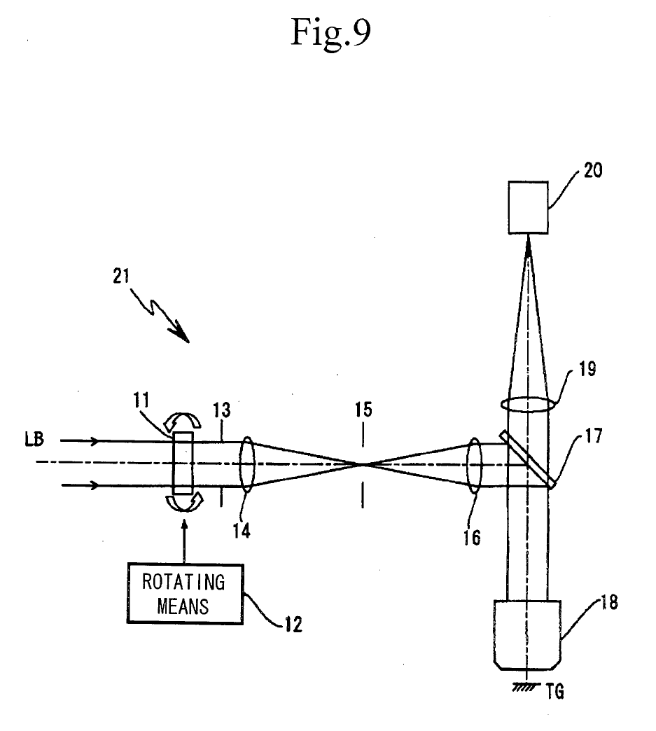

FIG. 9 shows a configuration example 21 of a microscope which uses laser beams as they are, and the difference between FIG. 8 is that a laser beam (LB) is directly irradiated with respect to a diffractive lens element 11. In other words, if laser beams can be used as parallel beams to begin with, the optical fiber 9 and the condenser lens 10 mentioned above can be dispensed with.

In addition, various embodiments, such as the configuration of transmission light type, not limited to those configurations indicated in FIG. 8 and FIG. 9 are possible.

As is evident from what is described above, according to the invention according to claim 1, because the optical functions of both a lens or a lens array (two-dimensional array type) and a random phase plate are provided in one optical element, it becomes unnecessary to employ separate optical elements having each function.

Further, according to the invention according to claim 2 and claim 3, by rotating the diffractive lens element, speckle patterns can be suppressed, while at the same time, because there is no need to employ a diffusion plate, it is possible to achieve a reduction in energy loss, and an improvement in light utilization efficiency.

1. A diffractive lens element in which a cross-sectional form is formed in a step shape by forming multiple recessed portions having different depths with respect to a transparent base material, and has optical functions of one lens or a plurality of lenses and a random phase plate in combination, said diffractive lens element characterized in that recessed portions having irregular phase variations are formed by adding or superimposing a variation amount in accordance with a random number onto depths of recessed portions constituting steps which are equivalent in value to a lens or a lens array.

2. An illumination apparatus for obtaining a uniform illumination light from which speckles are eliminated using the diffractive lens element according to claim 1, characterized in that said illumination apparatus is provided with a laser light source and rotating means for rotating said diffractive lens element.

3. The illumination apparatus according to claim 2, said illumination apparatus characterized in that a light from the laser light source is irradiated on the diffractive lens element via a condenser lens after being propagated by a optical fiber.
